(19) United States
(12) Patent Application Publication
(10) Pub. No.: US 2015/0280459 A1
(43) Pub. Date: Oct. 1, 2015

(54) CHARGER

(71) Applicant: SANYO ELECTRIC CO., LTD., Osaka (JP)

(72) Inventors: TATEHITO Yagi, Osaka (JP); Ryuzon Sugihara, Osaka (JP)

(21) Appl. No.: 14/437,324

(22) PCT Filed: Oct. 29, 2013
(86) PCT No.: PCT/JP2013/006378

§ 371 Date: Apr. 21, 2015

(30) Foreign Application Priority Data
Nov. 7, 2012 (JP) 2012-245016
Dec. 7, 2012 (JP) 2012-267745

(51) Int. Cl. H02J 7/00

(52) U.S. Cl. CPC H02J 7/007

(57) ABSTRACT

The charger includes a voltage conversion circuit that generates a DC voltage, output terminals that supply the DC voltage to a charging target, an auxiliary power supply interposed between a pair of electric paths connecting the output terminals and the voltage conversion circuit, a voltage detection circuit that detects a terminal voltage at the auxiliary power supply, a voltage conversion control unit operated by receiving power supply from the auxiliary power supply, the voltage conversion control unit configured to output a control signal that puts the voltage conversion circuit into a starting state in a period during which charging of the auxiliary power supply is necessary in a disconnected state in which the charging target is not connected to the output terminals, and that puts the voltage conversion circuit into a stopping state in a period during which the charging of the auxiliary power supply is not necessary, and a detection mechanism that detects a change in state from the disconnected state to a connected state in which the charging target is connected to the output terminals.

### TECHNICAL FIELD

The present invention relates to a charger, particularly to a charger that converts a supply voltage from an AC power supply and charges a charging target.

### BACKGROUND ART

There are developed various chargers that convert a supply voltage from the AC power supply and charge the charging target (for example, see PTL 1). The charger mainly includes a voltage conversion circuit configured to generate a DC voltage from a supply voltage from the AC power supply in a starting state, and a pair of output terminals configured to supply the DC voltage to the charging target.

From the viewpoint of reducing standby power consumption as much as possible in a disconnected state in which the charging target is not connected to the pair of output terminals, there is also developed a charger including a voltage conversion control unit that controls the voltage conversion circuit to stop operation in the disconnected state in principle (for example, see PTLs 3 and 4). The charger includes an auxiliary power supply, and the voltage conversion control unit basically receives the power supplied from the auxiliary power supply while the operation of the voltage conversion circuit is stopped.

The voltage conversion control unit puts a latch relay into a closed state to start the voltage conversion circuit, and charges the auxiliary power supply at time a terminal voltage at the auxiliary power supply possibly falls below a minimum operating voltage of the voltage conversion control unit to arise necessity of the charging of the auxiliary power supply. For example, some auxiliary power supplies include secondary batteries such as a nickel-metal hydride battery and a lithium ion battery.

### CITATION LIST

### Patent Literatures

PTL 1: Unexamined Japanese Patent Publication No. 8-205418
PTL 2: Unexamined Japanese Patent Publication No. 2008-187767
PTL 3: Unexamined Japanese Patent Publication No. 2010-016984
PTL 4: Unexamined Japanese Patent Publication No. 2011-024299

### SUMMARY OF THE INVENTION

### Technical Problem

Nowadays, portable electronic devices such as a mobile phone and a portable music player are widely used, and in recent years, a multifunctional mobile phone and a tablet terminal, which consume much power compared with the conventional mobile phone, are becoming increasingly common. For this reason, a user carries not only the portable electronic device, but also frequently carries the charger compatible with the portable electronic device for the purpose of the use and charging of the portable electronic device at a visiting or lodging place. Therefore, there is a demand for further downsizing of the charger for convenience in carrying the charger with the user.

However, in the case where the latch relay is used, in addition to the latch relay, it is necessary to provide a latch circuit configured to operate the latch relay, for example. As a result, there is a problem in that the conventional charger hardly meets the demand for further downsizing.

The present invention has been devised to meet this demand, and an object thereof is to achieve downsizing of a charger having a configuration that can reduce standby power consumption as much as possible.

### Solution to Problem

In order to achieve the above object, the present invention provides a charger that converts a supply voltage from an AC power supply and charges a charging target. The charger includes a voltage conversion circuit configured to be connected to the AC power supply and to generate a DC voltage from the supply voltage in a starting state; a pair of output terminals configured to supply the DC voltage output from the voltage conversion circuit to the charging target, an auxiliary power supply interposed between a pair of electric paths connecting each of the output terminals and the voltage conversion circuit and configured to receive power supplied from the voltage conversion circuit, a voltage detection circuit configured to detect a terminal voltage at the auxiliary power supply and to output a detection result; a voltage conversion control unit operated by receiving power supply from the auxiliary power supply, the voltage conversion control unit configured to receive the detection result, and to output a control signal that puts the voltage conversion circuit into a starting state in a period during which charging of the auxiliary power supply is necessary in a disconnected state in which the charging target is not connected to the pair of output terminals, and puts the voltage conversion circuit into a stopping state in a period during which the charging of the auxiliary power supply is not necessary, and a detection mechanism configured to detect a change in state from the disconnected state to a connected state in which the charging target is connected to the pair of output terminals.

### Advantageous Effect of the Invention

The voltage conversion control unit of the charger of the present invention basically only receives the detection result from the voltage detection circuit and outputs the control signal. Accordingly, sparse power is enough to be supplied from the auxiliary power supply to the voltage conversion control unit. In the disconnected state, because conduction between the auxiliary power supply and the charging target is not established, the electric charge lost from auxiliary power supply in the disconnected state is substantially as small as a part supplied to the voltage conversion control unit and a self-discharge part. Therefore, because a frequency of the charging of the auxiliary power supply can be decreased, a period during which the voltage conversion circuit is started to charge the auxiliary power supply is negligible in a period of the disconnected state. Accordingly, in the disconnected state, the standby power consumption can be reduced to substantial zero.

As used herein, “the standby power consumption is substantial zero” means that a measured value of the standby power consumption is less than 5 mW.

The latch relay is not used in the configuration of the charger of the present invention. Therefore, the necessity of the latch circuit configured to operate the latch relay, etc. is eliminated, so that a number of circuit components can be decreased.

As described above, the present invention can achieve the downsizing of the charger having the configuration that can reduce the standby power consumption as much as possible.

### BRIEF DESCRIPTION OF DRAWINGS

FIG. 1 is a circuit diagram illustrating an entire configuration of charger 1000 according to a first exemplary embodiment.

FIG. 2 is a view illustrating a fluctuation in terminal voltage at electric double layer capacitor 300, the terminal voltage being detected by voltage detection circuit 400.

FIG. 3 is a circuit diagram illustrating an entire configuration of charger 2000 according to a second exemplary embodiment.

FIG. 4 is a circuit diagram illustrating an entire configuration of charger 3000 according to a third exemplary embodiment.

FIG. 5 is a timing chart illustrating an operation of charger 3000 of the third exemplary embodiment.

FIG. 6 is a circuit diagram illustrating an entire configuration of charger 4000 according to a fourth exemplary embodiment.

FIG. 7 is a circuit diagram illustrating an entire configuration of a charger according to a modification.

### DESCRIPTION OF EMBODIMENTS

### First Exemplary Embodiment

### Configuration of Charger 1000

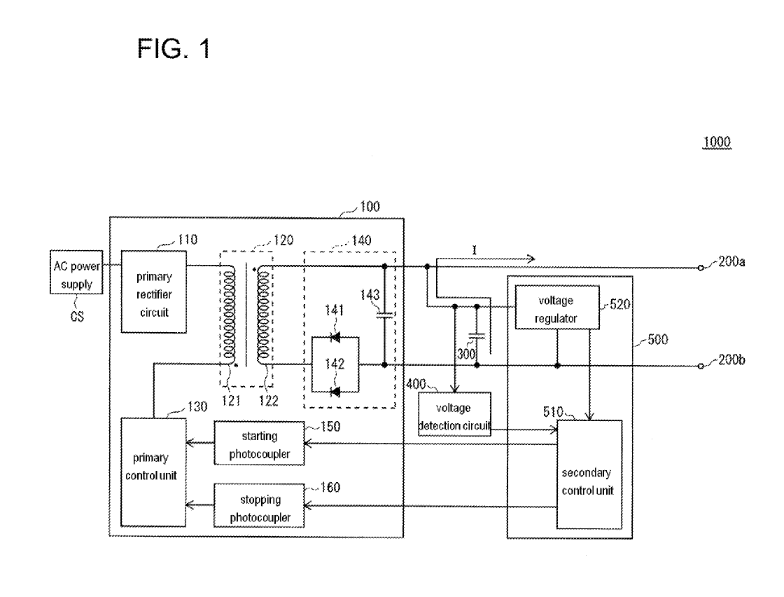

FIG. 1 is a circuit diagram illustrating an entire configuration of charger 1000 according to a first exemplary embodiment. Charger 1000 converts a supply voltage from AC power supply CS that is an AC power supply, and charges a portable electronic device that is a charging target. Charger 1000 includes voltage conversion circuit 100, output terminals 200a and 200b, electric double layer capacitor 300, voltage detection circuit 400, and voltage conversion control unit 500. An input side of charger 1000 is connected to AC power supply CS, and an output side is connected to the portable electronic device through output terminals 200a and 200b. AC power supply CS is 100-VAC to 250-VAC commercial power sources installed in a house and the like.

### <Voltage Conversion Circuit 100>

Voltage conversion circuit 100 is connected to AC power supply CS and generates a DC voltage from a supply voltage from AC power supply CS. Voltage conversion circuit 100 includes a converter and a signal transmitter.

### (Converter)

The converter converts the supply voltage from AC power supply CS into the DC voltage. The converter includes primary rectifier circuit 110, power transformer 120, primary control unit 130, and secondary rectifier circuit 140.

The converter is an AC/DC converter, which performs AC/DC conversion in a starting state while not performing the AC/DC conversion in a stopping state. The starting state and the stopping state of the converter are controlled by a control signal output from voltage conversion control unit 500. Specifically, a starting signal putting the converter into the starting state and a stopping signal putting the converter into the stopping state are input to the converter, thereby controlling the converter. Once the converter receives the starting signal, the converter keeps the starting state until receiving the stopping signal. Once the converter receives the stopping signal, the converter keeps the stopping state until receiving the starting signal. An electric path connecting AC power supply CS and voltage conversion circuit 100 is interrupted in the case where the converter is in the stopping state.

Primary Rectifier Circuit 110

Primary rectifier circuit 110 rectifies the supply voltage from AC power supply CS, and generates the DC voltage. For example, primary rectifier circuit 110 includes a diode bridge.

Power Transformer 120

Power transformer 120 includes primary winding 121 and secondary winding 122. An AC voltage generated by primary control unit 130 is input to primary winding 121. The AC voltage is induced in secondary winding 122 according to a winding ratio of primary winding 121 and secondary winding 122.

Primary Control Unit 130

Primary control unit 130 is an AC voltage generator that generates the AC voltage supplied to primary winding 121 based on the DC voltage output from primary rectifier circuit 110. A switching element such as an FET (Field Effect Transistor) or an IGBT (Insulated Gate Bipolar Transistor) is incorporated in primary control unit 130, and the AC voltage is generated from the DC voltage output from primary rectifier circuit 110 by turning on and off the switching element.

Secondary Rectifier Circuit 140

Secondary rectifier circuit 140 rectifies the AC voltage induced in secondary winding 122, and is connected to both ends of secondary winding 122. Secondary rectifier circuit 140 includes diodes 141 and 142 connected in parallel with each other and capacitor 143.

### (Signal Transmitter)

The signal transmitter includes starting photocoupler 150 and stopping photocoupler 160. The signal transmitter transmits the control signal output from voltage conversion control unit 500 to the converter. Starting photocoupler 150 transmits the starting signal in the control signals in order to put the voltage conversion circuit 100 into the starting state. Stopping photocoupler 160 transmits the stopping signal in the control signals in order to put the voltage conversion circuit 100 into the stopping state.

<Output Terminals 200a and 200b>

Output terminals 200a and 200b are used to supply the DC voltage output from voltage conversion circuit 100 to the charging target. For example, output terminals 200a and 200b correspond to a V_{bus} terminal and a GND terminal in a USB (Universal Serial Bus) connector. A second voltage that is an input voltage to the charging target is output between output terminals 200a and 200b. At this point, the charging target may include or not include a charging battery.

### <Electric Double Layer Capacitor 300>

Electric double layer capacitor 300 is an auxiliary power supply that supplies power to voltage conversion control unit 500 while an operation of voltage conversion circuit 100 is stopped in a disconnected state in which the charging target is not connected to the output terminal (hereinafter, simply referred to as a “disconnected state”). Electric double layer capacitor 300 is interposed between a pair of electric paths connecting output terminals 200a and 200b and voltage conversion circuit 100. Electric double layer capacitor 300 receives the power supplied from voltage conversion circuit 100. In the first exemplary embodiment, it is assumed that the output voltage from electric double layer capacitor 300 is equal to the input voltage to the charging target. In order to use the electric double layer capacitor as the auxiliary power supply, for example, desirably electric double layer capacitor 300 has an electrostatic capacity of 0.22 F or more.

As described above, the auxiliary power supply of the first exemplary embodiment includes electric double layer capacitor 300. The auxiliary power supply, which includes electric double layer capacitor 300, allows downsizing of charger 1000. That is, the electric double layer capacitor has a capacity larger than that of a conventional standard electrolytic capacitor, and the electric double layer capacitor is smaller than a battery while having a capacity enough to be used as the auxiliary power supply. The necessity of the charging circuit is eliminated unlike the use of the battery, so that the number of circuit components can be decreased. Therefore, the downsizing of charger 1000 is further achieved.

### <Voltage Detection Circuit 400>

Voltage detection circuit 400 detects a terminal voltage at electric double layer capacitor 300 that is the auxiliary power supply. A detection result of voltage detection circuit 400 is output to secondary control unit 510.

### <Voltage Conversion Control Unit 500>

Voltage conversion control unit 500 controls the starting state and the stopping state of the converter in voltage conversion circuit 100. Voltage conversion control unit 500 includes secondary control unit 510 and voltage regulator 520, and is operated by receiving power supplied from electric double layer capacitor 300.

Secondary control unit 510 receives the detection result of voltage detection circuit 400, and outputs the control signal to the converter of voltage conversion circuit 100. In a connected state in which the charging target is connected to output terminals 200a and 200b (hereinafter, simply referred to as a “connected state”), secondary control unit 510 controls the converter to be constantly in the starting state. On the other hand, in the disconnected state, secondary control unit 510 controls voltage conversion circuit 100 to be in the starting state in a period during which charging of electric double layer capacitor 300 is necessary, and secondary control unit 510 controls voltage conversion circuit 100 to be in the stopping state in a period during which the charging of electric double layer capacitor 300 is not necessary.

Whether the charging of electric double layer capacitor 300 is necessary is determined based on information on the terminal voltage at electric double layer capacitor 300. The terminal voltage is output from voltage detection circuit 400. For example, it is assumed that a period during which the terminal voltage at electric double layer capacitor 300 is less than or equal to 110% of a minimum operating voltage of secondary control unit 510 is the period during which the charging of electric double layer capacitor 300 is necessary. That is, in the disconnected state, voltage conversion control unit 500 puts voltage conversion circuit 100 into the starting state in the period during which the terminal voltage at electric double layer capacitor 300 is less than or equal to 110% of the minimum operating voltage of secondary control unit 510. On the other hand, it is assumed that a period during which the terminal voltage at electric double layer capacitor 300 exceeds 110% of the minimum operating voltage of secondary control unit 510 is the period during which the charging of electric double layer capacitor 300 is not necessary. Hereinafter, the terminal voltage at electric double layer capacitor 300, which is a criterion for the necessity of the charging of electric double layer capacitor 300, is simply referred to as a “charge reference voltage”.

As used herein, a numerical value of 110% can properly be changed according to the electrostatic capacity of electric double layer capacitor 300 and specifications (such as power consumption) of secondary control unit 510. The charging of electric double layer capacitor 300 is necessary when the terminal voltage of electric double layer capacitor 300 is higher than the minimum operating voltage of secondary control unit 510, which allows at least the power necessary for the output of the starting signal to be output to secondary control unit 510.

Voltage regulator 520 stably outputs a constant voltage greater than or equal to the minimum operating voltage of secondary control unit 510 to secondary control unit 510. Even if the output voltage from electric double layer capacitor 300 fluctuates, the voltage output to secondary control unit 510 can be kept constant by providing voltage regulator 520.

Basically, voltage conversion control unit 500 receives the detection result from the voltage detection circuit 400, and outputs the control signal to starting photocoupler 150 and stopping photocoupler 160. The control signal is not always output in a constant period, but the control signal is output only when it is necessary to switch the starting state and the stopping state of the converter in voltage conversion circuit 100. For this reason, sparse power is enough to be supplied from electric double layer capacitor 300 to voltage conversion control unit 500.

In the disconnected state, because electric conduction is not established between electric double layer capacitor 300 and the charging target, basically an electric charge is not emitted from electric double layer capacitor 300 to the charging target. That is, in the disconnected state, the electric charge lost from electric double layer capacitor 300 substantially consists of a part supplied to voltage conversion control unit 500 and a self-discharge part. Because the sparse charge is lost from electric double layer capacitor 300 in the disconnected state, electric double layer capacitor 300 has an extremely low frequency of the charging. Therefore, a period during which the charging of electric double layer capacitor 300 is performed has a low percentage in a period of the disconnected state. In other words, a period during which voltage conversion circuit 100 is started has a low percentage in the period of the disconnected state, so that the standby power consumption can be reduced to substantial zero in the disconnected state.

### [Method for Detecting Connection to Charging Target]

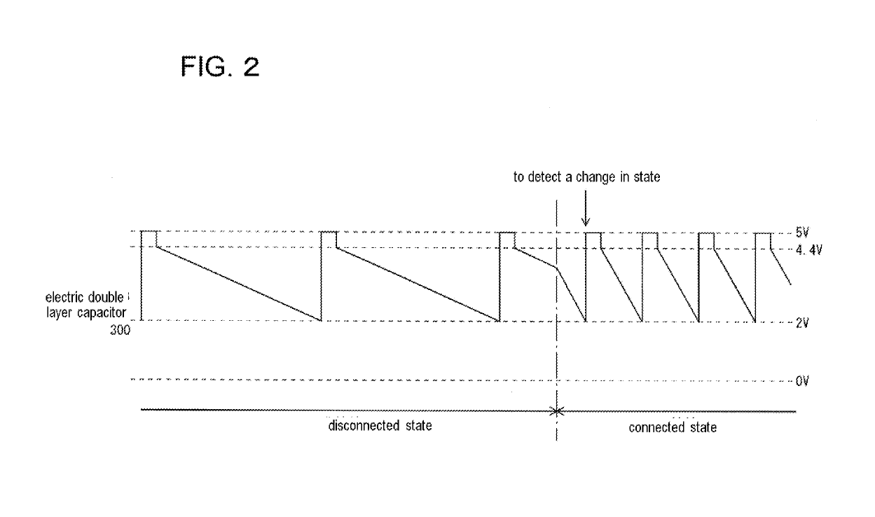

Charger 1000 of the first exemplary embodiment also includes a detection mechanism that detects a change in state from the disconnected state to the connected state. The detection mechanism of the first exemplary embodiment includes electric double layer capacitor 300, voltage detection circuit 400, and voltage conversion control unit 500. A principle detecting the change in state will be described below with reference to FIGS. 1 and 2.

FIG. 2 is a view illustrating a fluctuation in terminal voltage at electric double layer capacitor 300, the terminal voltage being detected by voltage detection circuit 400. In FIG. 2, electric double layer capacitor 300 is fully charged at the terminal voltage of 5 V, electric double layer capacitor 300 starts discharge at the voltage of 4.4 V, and the charge reference voltage is set to 2 V.

Because the charging target is not connected to output terminals 200a and 200b in the disconnected state, output terminals 200a and 200b are in a floating state. For this reason, the electric charge discharged from electric double layer capacitor 300 basically consists of only a self-discharge part of electric double layer capacitor 300 and a part supplied to voltage conversion control unit 500. Accordingly, as illustrated in FIG. 2, an amount of decrease in terminal voltage at electric double layer capacitor 300 per unit time detected by voltage detection circuit 400 is relatively small in the disconnected state.

On the other hand, when the change in state from the disconnected state to the connected state is generated, as indicated by current I in FIG. 1, there is formed a discharge route in which the electric charge accumulated in electric double layer capacitor 300 is discharged to the charging target through output terminals 200a and 200b. For this reason, as illustrated in FIG. 2, the amount of decrease in terminal voltage at electric double layer capacitor 300 per unit time detected by voltage detection circuit 400 is larger than that in the disconnected state. Secondary control unit 510 determines whether the change in state is generated based on the amount of decrease in terminal voltage detected by voltage detection circuit 400.

Secondary control unit 510 previously stores time necessary for the terminal voltage at electric double layer capacitor 300 to become the charge reference voltage since the full charging voltage in the disconnected state. When the change in state to the connected state is generated, the time necessary to become the charge reference voltage is largely shortened compared with the case of the disconnected state. Further, secondary control unit 510 also stores a threshold, which is fixed in consideration of the time necessary to become the charge reference voltage in the disconnected state and the time necessary to become the charge reference voltage in the connected state. Secondary control unit 510 monitors the time necessary to become the charge reference voltage since the full charging voltage, and determines whether the change in state from the disconnected state to the connected state is generated by determining whether the time is less than or equal to the threshold. Secondary control unit 510 determines that the change in state is generated when the time necessary to become the charge reference voltage since the full charging voltage is less than or equal to the threshold, and secondary control unit 510 determines that the change in state is not generated when the time exceeds the threshold.

In the above description, the change in state is detected based on the time necessary to become the charge reference voltage since the full charging voltage. However, the detection method is not limited to the above description. In FIG. 2, for easier understanding of explanations, there is a given period until the change in state from the disconnected state to the connected state is detected since the change in state is generated. However, because electric double layer capacitor 300 extremely rapidly performs the discharges in association with the change in state, the period until the change in state is detected since the change in state is generated is extremely short, and the change in state is generated and detected at the substantially same time.

When determining that the change in state is generated, secondary control unit 510 outputs the starting signal to starting photocoupler 150 in order to put the converter of voltage conversion circuit 100 into the starting state. On the other hand, voltage conversion circuit 100 keeps converter in the stopping state when determining that the change in state is not generated. That is, secondary control unit 510 does not perform a special operation when determining that the change in state is not generated.

As described above, the detection mechanism of the first exemplary embodiment detects the change in state based on the fluctuation in terminal voltage associated with the change in state at electric double layer capacitor 300. In the first exemplary embodiment, it is not necessary to separately provide a special configuration that detects the change in state. Accordingly, a function of the detection mechanism can be added while a size of the charger is unchanged.

### [Summary]

PTLs 3 and 4 disclose a technology of opening and closing the electric path connecting the AC power supply and the voltage conversion circuit using the latch relay. However, as described above, the use of the latch relay leads to the problem in that the downsizing is hardly achieved. In the case where the latch relay is used in the charger on the assumption that the user carries the charger, there is a problem in that the opened state and the closed state of the latch relay may be switched due to a vibration applied to the charger in carrying the charger, a drop of the charger, or the like. There is also a problem in that cost of the latch relay is relatively high.

On the other hand, in the charger of the first exemplary embodiment, the standby power consumption can be reduced to substantial zero with no use of the latch relay. Because the latch relay is not used, a circuit configuration and a circuit operation of the charger can be simplified to achieve the downsizing of the charger. Additionally, in the first exemplary embodiment, the electric double layer capacitor is used as the auxiliary power supply. Therefore, as described above, the downsizing of the charger can further be achieved.

### Second Exemplary Embodiment

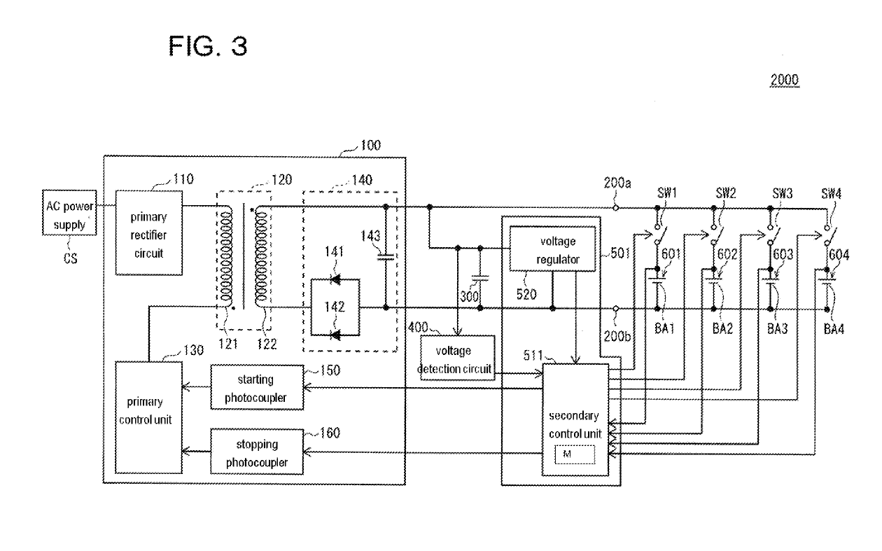

FIG. 3 is a circuit diagram illustrating an entire configuration of charger 2000 according to a second exemplary embodiment. Charger 2000 of the second exemplary embodiment differs from charger 1000 of the first exemplary embodiment in that the charging target is at least one rechargeable battery. In FIG. 3, the configuration identical to that of charger 1000 is designated by the identical reference mark. In the second exemplary embodiment, it is also assumed that the output voltage from electric double layer capacitor 300 is equal to the input voltage to the charging target.

The charging target of charger 2000 is a rechargeable battery having an appearance of a dry-cell battery such as a AA battery and a AAA battery, and four rechargeable batteries BA1 to BA4 are illustrated in FIG. 3. Rechargeable batteries BA1 to BA4 are rechargeable secondary battery such as a lithium ion battery and a nickel-metal hydride battery. As illustrated in FIG. 3, charger 2000 further includes four rechargeable battery mounting units 601 to 604 in which rechargeable batteries BA1 to BA4 are mounted.

Voltage conversion control unit 501 of charger 2000 includes voltage regulator 520 and secondary control unit 511. Voltage regulator 520 has the configuration similar to that of charger 1000, and secondary control unit 511 differs from that of charger 1000. Secondary control unit 511 of charger 2000 detects the terminal voltages at rechargeable battery mounting units 601 to 604, respectively. Secondary control unit 511 detects the terminal voltage at each of rechargeable battery mounting units 601 to 604, thereby detecting that the rechargeable battery that is the charging target is connected to charger 2000. Thus, secondary control unit 511 acts as the detection mechanism that detects the change in state from the disconnected state to the connected state. Another method may be used as the method for detecting the connection to the rechargeable battery.

Secondary control unit 511 also controls opening and closing operations of charging switches SW1 to SW4 interposed between output terminal 200a and rechargeable battery mounting units 601 to 604, respectively. When secondary control unit 511 determines that the rechargeable batteries are not mounted in rechargeable battery mounting units 601 to 604, secondary control unit 511 puts all charging switches SW1 to SW4 into the opened state while keeping the converter of voltage conversion circuit 100 in the stopping state. When secondary control unit 511 determines that the rechargeable batteries BA1 to BA4 are mounted in rechargeable battery mounting units 601 to 604, secondary control unit 511 puts charging switches, which correspond to the rechargeable battery mounting units in which the rechargeable batteries are mounted, into the closed state while outputting the starting signal to starting photocoupler 150 of voltage conversion circuit 100.

The charging is started when rechargeable batteries BA1 to BA4 are mounted. When charging progresses and secondary control unit 511 detects the full charging of each rechargeable battery, secondary control unit 511 puts the corresponding charging switch into the opened state to stop the charging. At this point, in the case where the rechargeable battery is a nickel-metal hydride battery or a nickel-cadmium battery, secondary control unit 511 measures battery voltage, and detects the full charging when a gradient of the increase in battery voltage to the time is smaller than a predetermined value, when a peak voltage is detected, or when −ΔV (=voltage drop) of the battery voltage is detected.

Voltage conversion control unit 501 includes secondary control unit 511 provided with storage M.

When detecting the full charging of each of the rechargeable batteries, secondary control unit 511 stores the detection of the full charging of each rechargeable battery, namely, information on the detection of the full charging in the storage.

Secondary control unit 511 includes a microcomputer, and the information on the detection of the full charging, which is stored in the storage, is retained in an operating state (=the state in which voltage regulator 520 outputs a constant voltage greater than or equal to the minimum operating voltage of secondary control unit 511 to secondary control unit 511) of secondary control unit 511.

Even if charger 2000 is detached from AC power supply CS while the rechargeable battery is mounted, or even if a switch (not illustrated) is turned off to interrupt the supply of the power, because charger 2000 includes electric double layer capacitor 300 as auxiliary power supply, secondary control unit 511 is put into the operating state to be able to retain the information on the detection of the full charging as long as the voltage greater than or equal to the minimum operating voltage is supplied to secondary control unit 511 through voltage regulator 520.

For example, the terminal voltage at electric double layer capacitor 300 is decreased from about 7.0 V to about 3.2 V due to the discharge, voltage regulator 520 outputs about 3.0 V such that the microcomputer of secondary control unit 511 is stably operated. Actually, voltage regulator 520 can output about 3.0 V when the voltage at electric double layer capacitor 300 is greater than or equal to about 3.0 V. Because secondary control unit 510 has the minimum operating voltage of about 3.0 V, secondary control unit 510 can be operated when the voltage at electric double layer capacitor 300 is greater than or equal to about 3.0 V. At this point, the charge reference voltage can be set to about 3.2 V or about 3.3 V.

When electric double layer capacitor 300 supplies the voltage greater than or equal to minimum operating voltage to secondary control unit 511 through voltage regulator 520 after the supply of the power is interrupted, the supply of the power is restarted by attaching charger 2000 to AC power supply CS or by turning on the switch (not illustrated). At this point, based on the information on the detection of the full charging of the rechargeable battery, which is retained in the storage of secondary control unit 511, secondary control unit 511 controls the rechargeable battery not to restart the charging, the rechargeable battery being in the mounted state while the information on the detection of the full charging is retained.

The rechargeable battery, which is in the mounted state while the information on the detection of the full charging is retained, is not recharged and prevented from becoming fully charged, so that the higher state of the charging capacity or overcharge of the rechargeable battery can be reduced. Therefore, an adverse effect on the battery can be prevented, an adverse effect on a lifetime of the battery can be prevented, a liquid leakage can be suppressed, and energy reduction can be achieved by not recharging the battery.

The above action and effect can be obtained even if the interruption of the supply of the power is generated by power outage or momentary power interruption (momentary power outage).

The time for which electric double layer capacitor 300 that is the auxiliary power supply can maintain the operating state of secondary control unit 511 (as well as voltage regulator 520 and voltage detection circuit 400) since the supply of the power is interrupted ranges from 3 hours to 4 hours when electric double layer capacitor 300 is in the full charging state (upper-limit voltage state). When the terminal voltage at electric double layer capacitor 300 is about 3.2 V of the charge reference voltage, secondary control unit 511 can be operated for several minutes to 30 minutes because electric double layer capacitor 300 can discharge up to about 3.0 V as described above. That is, the rechargeable battery, which is in the mounted state while the information on the detection of the full charging is retained, is not recharged during the above time. For example, voltage conversion circuit 100 is put into the starting state, and the time necessary to charge electric double layer capacitor 300 can be set to about 2 minutes or about 1 minute to about 4 minutes.

All rechargeable batteries BA1 to BA4 can be mounted in rechargeable battery mounting units 601 to 604, and the rechargeable batteries can be mounted in some of rechargeable battery mounting units 601 to 604. The detachment of rechargeable batteries BA1 to BA4 is detected by detecting the terminal voltages at the rechargeable battery mounting units 601 to 604 similarly to the mounting.

### Third Exemplary Embodiment

In the first and second exemplary embodiments, the charger has the configuration in which the output voltage from the electric double layer capacitor is equal to the input voltage to the charging target. In a third exemplary embodiment, a description will be given of a configuration of the charger in the case where a first voltage that is the output voltage from the electric double layer capacitor differs from a second voltage that is the input voltage to the charging target, particularly in the case where the output voltage from the electric double layer capacitor is higher than the input voltage to the charging target.

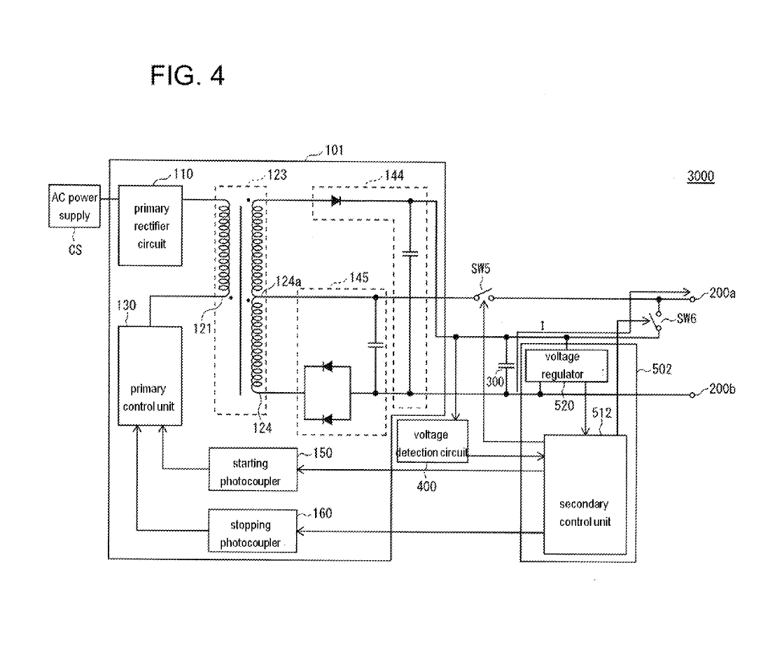

FIG. 4 is a circuit diagram illustrating an entire configuration of charger 3000 according to the third exemplary embodiment. In FIG. 4, the configuration identical to that of charger 1000 is designated by the identical reference mark.

Voltage conversion circuit 101 of the third exemplary embodiment differs from voltage conversion circuit 100 of charger 1000 in that the output voltage (first voltage) from electric double layer capacitor 300 and the input voltage (second voltage) to the charging target are separately output. Therefore, voltage conversion circuit 100 includes a converter that converts the supply voltage into the first voltage and the second voltage.

Secondary winding 124 of power transformer 123 constituting the converter includes center tap 124a. First and second secondary rectifier circuits 144 and 145 connected to secondary winding 124 generate the output voltage from electric double layer capacitor 300 and the input voltage to the charging target by rectifying the AC voltage induced in secondary winding 124. Specifically, first secondary rectifier circuit 144 is connected to both the ends of secondary winding 124 and generates the output voltage from electric double layer capacitor 300. Second secondary rectifier circuit 145 is connected to one end and center tap 124a of secondary winding 124 and generates the input voltage to the charging target.

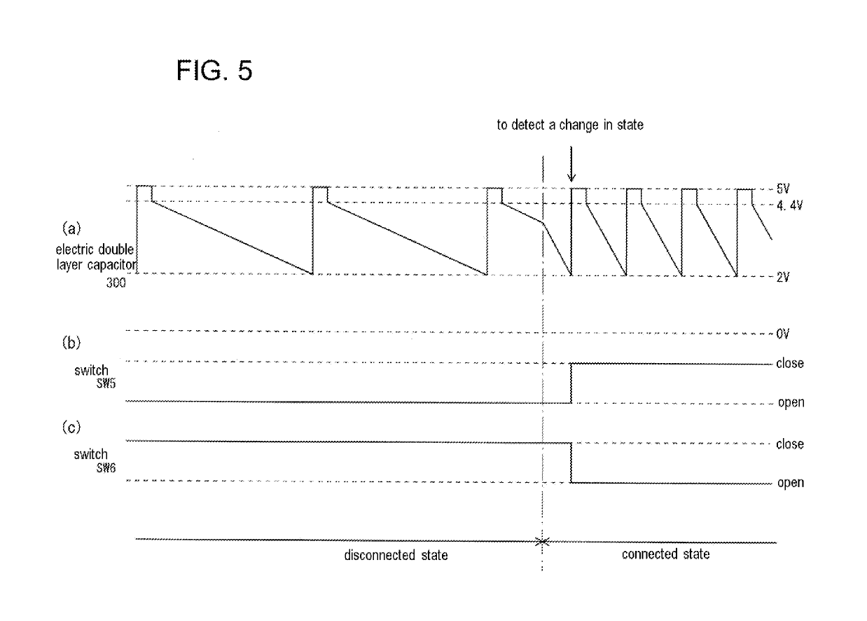

Charger 3000 further includes switch SW5 interposed in the electric path connecting second secondary rectifier circuit 145 and output terminal 200a and switch SW6 interposed in the electric path connecting electric double layer capacitor 300 and output terminal 200a. The opening and closing operations of switches SW5 and SW6 are controlled by secondary control unit 512 of voltage conversion control unit 502. The detailed opening and closing operation will be described below with reference to FIG. 5.

FIG. 5 is a timing chart illustrating the operation of charger 3000 of the third exemplary embodiment. FIG. 5(a) illustrates a fluctuation in terminal voltage at electric double layer capacitor 300, the terminal voltage being detected by voltage detection circuit 400. FIGS. 5(b) and 5(c) illustrate opened and closed states of switches SW5 and SW6.

In the disconnected state, it is not necessary to output the input voltage of the charging target to output terminals 200a and 200b. At the same time, it is necessary to detect whether the charging target is connected. When the change in state is generated, current I is passed through electric double layer capacitor 300 through the route in FIG. 4. Therefore, it is necessary to put the electric path connecting second secondary rectifier circuit 145 and output terminal 200a into the non-conduction state, and it is necessary to put the electric path connecting electric double layer capacitor 300 output terminal 200a in the conduction state. Accordingly, secondary control unit 512 controls switch SW5 into the opened state, and switch SW6 into the closed state.

Based on the terminal voltage, detected by voltage detection circuit 400, at the electric double layer capacitor 300, secondary control unit 512 detects the change in state from the disconnected state to the connected state by the method similar to that of the first exemplary embodiment. In order to supply the power to the charging target after the change in state to the connected state, it is necessary to put the electric path connecting second secondary rectifier circuit 145 and output terminal 200a into the conduction state. In order to prevent the excess voltage from being output to the charging target, it is necessary to put the electric path connecting electric double layer capacitor 300 and output terminal 200a into the non-conduction state. Accordingly, after the change in state, secondary control unit 512 controls switch SW5 into the closed state, and switch SW6 into the opened state.

### Fourth Exemplary Embodiment

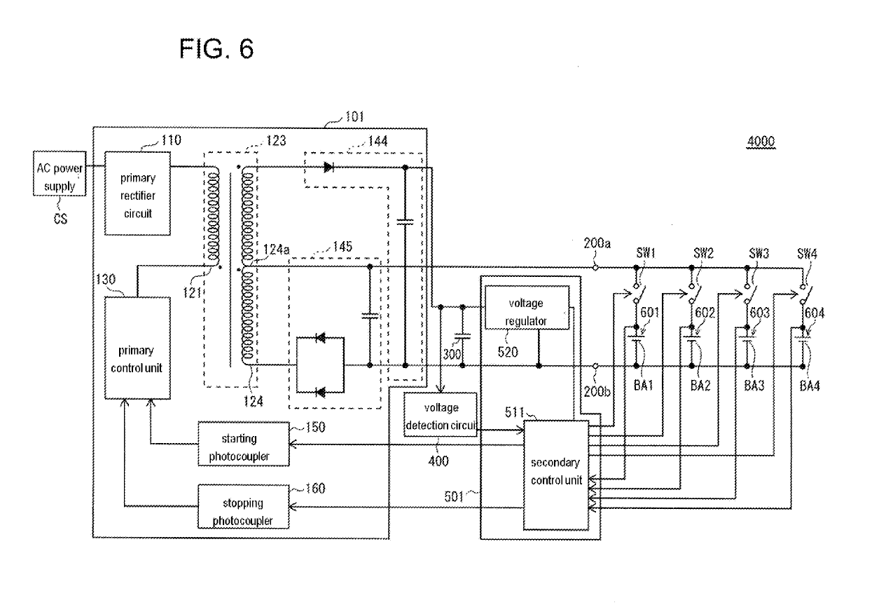

FIG. 6 is a circuit diagram illustrating an entire configuration of charger 4000 according to a fourth exemplary embodiment. In FIG. 6, the configuration identical to that of chargers 1000, 2000, and 3000 is designated by the identical reference mark.

In charger 4000 of the fourth exemplary embodiment, the charging target is rechargeable batteries BA1 to BA4 similarly to charger 2000 of the second exemplary embodiment. Charger 4000 of the fourth exemplary embodiment deals with the case where the output voltage from the electric double layer capacitor is higher than the input voltage to the charging target. Because the operation of each circuit of charger 4000 is similar to that of charger 2000 and charger 3000, see the descriptions of the second and third exemplary embodiments. The detection of the connection to the charging target in the fourth exemplary embodiment is similar to that of the second exemplary embodiment. Accordingly, the electric double layer capacitor is not used as the detection mechanism. Therefore, in charger 4000, it is not necessary to provide components equivalent to switches SW5 and SW6 in the charger 3000 of the third exemplary embodiment.

### [Modifications and Others]

Although the first to fourth exemplary embodiments are described above, the present invention is not limited to the first to fourth exemplary embodiments. For example, the following modifications can be made.

(1) The circuit configuration of the charger is not limited to the above exemplary embodiments. In the above exemplary embodiments, by way of example, it is assumed that the dedicated IC is used as the voltage conversion control unit. However, the present invention is not limited to the above exemplary embodiments.

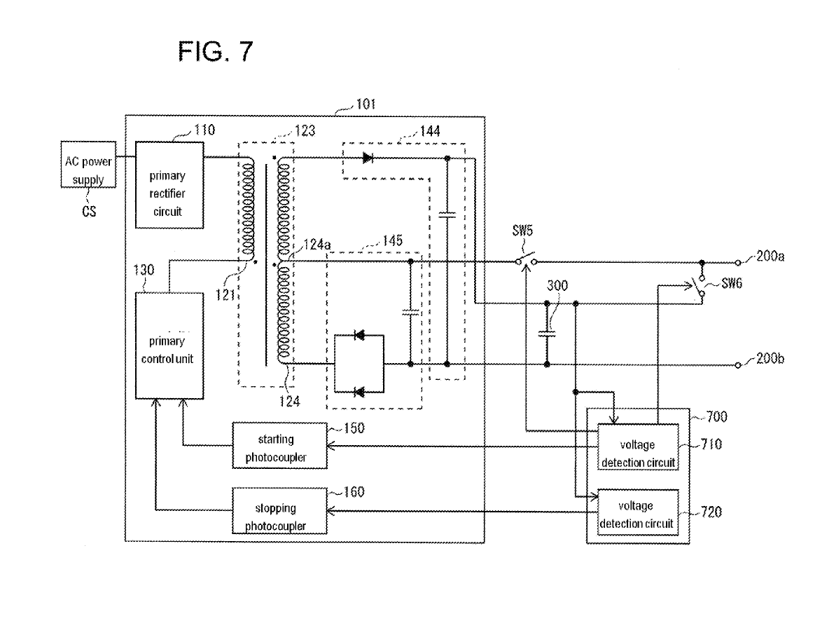

FIG. 7 is a circuit diagram illustrating an entire configuration of a charger according to a modification. FIG. 7 illustrates a modification of charger 3000 of the third exemplary embodiment. As illustrated in FIG. 7, in the modification, voltage detection circuit 400 and voltage conversion control unit 502 of charger 3000 are replaced with voltage detector 700 having the functions of voltage detection circuit 400 and voltage conversion control unit 502. Voltage detector 700 includes voltage detection circuits 710 and 720.

Voltage detection circuit 710 is used to detect that the terminal voltage at electric double layer capacitor 300 is decreased to 2 V that is the charge reference voltage. When detecting that the terminal voltage is decreased to 2 V, voltage detection circuit 710 outputs the starting signal to starting photocoupler 150 in order to charge electric double layer capacitor 300. On the other hand, voltage detection circuit 720 is used to detect that the terminal voltage at electric double layer capacitor 300 becomes 5 V that is the full charging voltage. When detecting that electric double layer capacitor 300 becomes the full charging voltage, voltage detection circuit 720 outputs the stopping signal to stopping photocoupler 160 to stop the charging of electric double layer capacitor 300.

Voltage detection circuit 710 also monitors the time the terminal voltage becomes 2V from 5 V, and detects the change in state from the disconnected state to the connected state based on the time. In the disconnected state, switch SW5 is put into the opened state, and switch SW6 is put into the closed state. In the connected state, switch SW5 is put into the closed state, and switch SW6 is put into the opened state. For example, voltage detection circuits 710 and 720 may include an operational amplifier.

(2) In the above exemplary embodiments, as to the secondary rectifier circuit that generates the input voltage (second voltage) to the charging target, the two diodes are connected in parallel with each other by way of example. However, the present invention is not limited to the two diodes, but only one diode may be used. There is no particular limitation to the number of diodes in the case where a plurality of diodes are connected in parallel with each other. The reason the plurality of diodes are connected in parallel with each other is that a loss of the diode is improved.

(3) In the above exemplary embodiments, the electric double layer capacitor is used as the auxiliary power supply. However, the present invention is not limited to the electric double layer capacitor. For example, a compact secondary battery or a compact electrolytic capacitor may be used instead of the electric double layer capacitor. However, in the case where the electric double layer capacitor is used as the auxiliary power supply, the downsizing of the charger can further be achieved as described above.

(4) In the third and fourth exemplary embodiments, by way of example, the output voltage from the electric double layer capacitor is higher than the input voltage to the charging target. On the other hand, in the case where the input voltage to the charging target is higher than the output voltage from the electric double layer capacitor, second secondary rectifier circuit is connected to both the ends of the secondary winding, and the first secondary rectifier circuit is connected to one end and the center tap of the secondary winding.

(5) In the first and third exemplary embodiments, the connection to the charging target is detected using the electric double layer capacitor. However, the present invention is not limited to the electric double layer capacitor. For example, a switch that physically detects the connection to the charging target may be provided.

(6) The above exemplary embodiments are examples used to easily describe the configuration of the present invention and the action and effect obtained from the configuration. Accordingly, there is no particular limitation to the exemplary embodiments of the present invention except an essential constituent of the present invention. Each of the drawings only schematically illustrates arrangements of the constituents to the extent that the present invention can be understood, and the present invention is not limited to the examples illustrated in each of the drawings. Sometimes part of the configuration is omitted in the drawing for the sake of easy understanding. The term “to” used to indicate a numerical range includes numerical values at both ends.

### INDUSTRIAL APPLICABILITY

For example, the present invention can suitably be applied to the charger or the like for the portable electronic device in which the low standby power consumption is demanded.

### REFERENCE MARKS IN THE DRAWINGS

100, 101 voltage conversion circuit
110 primary rectifier circuit
120 power transformer
121 primary winding
122 secondary winding
123 power transformer
124 secondary winding
124a center tap
130 primary control unit
140 secondary rectifier circuit
141, 142 diode
143 capacitor
144 first secondary rectifier circuit
145 second secondary rectifier circuit
150 starting photocoupler
160 stopping photocoupler
200a, 200b output terminal
300 electric double layer capacitor
400 voltage detection circuit
500, 501, 502 voltage conversion control unit
510, 511, 512 secondary control unit
520 voltage regulator
601 to 604 rechargeable battery mounting unit
700 voltage detector
710, 720 voltage detection circuit
1000 charger
CS AC power supply
BA1 to BA4 rechargeable battery
SW1 to SW4 charging switch
SW5, SW6 switch
M storage

1. A charger that converts a supply voltage from an AC power supply and charges a charging target, the charger comprising:
a voltage conversion circuit configured to be connected to the AC power supply and to generate a DC voltage from the supply voltage in a starting state;
a pair of output terminals configured to supply the DC voltage output from the voltage conversion circuit to the charging target;
an auxiliary power supply interposed between a pair of electric paths connecting each of the output terminals and the voltage conversion circuit, and configured to receive power supplied from the voltage conversion circuit;
a voltage detection circuit configured to detect a terminal voltage at the auxiliary power supply and to output a detection result;
a voltage conversion control unit operated by receiving power supply from the auxiliary power supply, the voltage conversion control unit configured to
receive the detection result, and
output a control signal that puts the voltage conversion circuit into the starting state in a period during which charging of the auxiliary power supply is necessary in a disconnected state in which the charging target is not connected to the pair of output terminals, and that puts the voltage conversion circuit into a stopping state in a period during which the charging of the auxiliary power supply is not necessary; and
a detection mechanism configured to detect a change in state from the disconnected state to a connected state in which the charging target is connected to the pair of output terminals, wherein
a first voltage that is an output voltage from the auxiliary power supply differs from a second voltage that is an input voltage to the charging target, and
the voltage conversion circuit separately outputs the first and second voltages,
wherein
the voltage conversion circuit includes a converter that converts the supply voltage into the first and second voltages,
the converter includes:
a power transformer that includes a primary winding and a secondary winding provided with a center tap;
a primary rectifier circuit that rectifies the supply voltage to generate the DC voltage;
an AC voltage generator that generates an AC voltage based on the DC voltage output from the primary rectifier circuit, and supplies the AC voltage to the primary winding; and
first and second secondary rectifier circuits that generate the first and second voltages by rectifying AC voltage induced in the secondary winding, respectively,
the first secondary rectifier circuit is connected to both ends of the secondary winding and generates the first voltage, and
the second secondary rectifier circuit is connected to one end and the center tap of the secondary winding and generates the second voltage.

2. The charger according to claim 1, wherein the auxiliary power supply is an electric double layer capacitor.

3. The charger according to claim 2, wherein
the detection mechanism includes the auxiliary power supply,
a discharge route in which an electric charge accumulated in the auxiliary power supply is discharged to the charging target is formed by the change in state, and
the change in state is detected based on a fluctuation in terminal voltage at the auxiliary power supply, the fluctuation in terminal voltage being associated with a formation of the discharge route.

4. The charger according to claim 3, wherein
the detection mechanism further includes the voltage detection circuit and the voltage conversion control unit,
an amount of decrease in terminal voltage at the auxiliary power supply per unit time in the connected state is larger than that in the disconnected state, the amount of decrease in terminal voltage being detected by the voltage detection circuit,
the voltage conversion control unit determines whether the change in state is generated based on the amount of decrease in terminal voltage detected by the voltage detection circuit,
the voltage conversion control unit puts the voltage conversion circuit into the starting state when determining that the change in state is generated, and
the voltage conversion control unit keeps the voltage conversion circuit in the stopping state when determining that the change in state is not generated.

5. The charger according to claim 2, wherein the charging target is at least one rechargeable battery,
the charger further comprising a rechargeable battery mounting unit in which the rechargeable battery is mounted,
wherein the detection mechanism detects the change in state by detecting a terminal voltage at the rechargeable battery mounting unit.

6. The charger according to claim 2, wherein an electrostatic capacity of the electric double layer capacitor is greater than or equal to 0.22 F.

7. The charger according to claim 1, wherein the voltage conversion control unit puts the voltage conversion circuit into the starting state in a period during which the terminal voltage at the auxiliary power supply is less than or equal to 110% of a minimum operating voltage of the voltage conversion control unit in the disconnected state.

8. The charger according to claim 1, wherein
the voltage conversion control unit includes:
a controller configured to receive the detection result, and output a control signal; and
a voltage regulator configured to output a constant voltage to the controller.

9. The charger according to claim 1, wherein
the voltage conversion circuit includes:
a converter configured to convert the supply voltage into the DC voltage; and
a signal transmitter configured to transmit the control signal to the converter.

10. The charger according to claim 9, wherein
the converter includes:
a power transformer that includes a primary winding and a secondary winding;
a primary rectifier circuit that rectifies the supply voltage to generate the DC voltage;
an AC voltage generator that generates an AC voltage based on the DC voltage output from the primary rectifier circuit, and supplies the AC voltage to the primary winding; and
a secondary rectifier circuit that generates the DC voltage by rectifying the AC voltage induced in the secondary winding.

11. (canceled)

12. (canceled)

13. The charger according to claim 1, wherein the voltage conversion control unit includes a secondary control unit provided with a storage, and
the secondary control unit stores information indicating that full charging of a rechargeable battery is detected in the storage, and
the secondary control unit retains the information indicating that the full charging of the rechargeable battery is detected, but does not restart the charging of the rechargeable battery in an operating state of the secondary control unit.

14. The charger according to claim 13, wherein the secondary control unit includes a microcomputer.

15. A charger that converts a supply voltage from an AC power supply and charges a charging target, the charger comprising:
a voltage conversion circuit configured to be connected to the AC power supply and to generate a DC voltage from the supply voltage in a starting state;
a pair of output terminals configured to supply the DC voltage output from the voltage conversion circuit to the charging target;
an auxiliary power supply interposed between a pair of electric paths connecting each of the output terminals and the voltage conversion circuit, and configured to receive power supplied from the voltage conversion circuit;
a voltage detection circuit configured to detect a terminal voltage at the auxiliary power supply and to output a detection result;
a voltage conversion control unit operated by receiving power supply from the auxiliary power supply, the voltage conversion control unit configured to
receive the detection result, and
output a control signal that puts the voltage conversion circuit into the starting state in a period during which charging of the auxiliary power supply is necessary in a disconnected state in which the charging target is not connected to the pair of output terminals, and that puts the voltage conversion circuit into a stopping state in a period during which the charging of the auxiliary power supply is not necessary; and
a detection mechanism configured to detect a change in state from the disconnected state to a connected state in which the charging target is connected to the pair of output terminals, wherein
the detection mechanism includes the auxiliary power supply,
a discharge route in which an electric charge accumulated in the auxiliary power supply is discharged to the charging target is formed by the change in state, and
the change in state is detected based on a fluctuation in terminal voltage at the auxiliary power supply, the fluctuation in terminal voltage being associated with a formation of the discharge route.

16. The charger according to claim 15, wherein
the detection mechanism further includes the voltage detection circuit and the voltage conversion control unit,
an amount of decrease in terminal voltage at the auxiliary power supply per unit time in the connected state is larger than that in the disconnected state, the amount of decrease in terminal voltage being detected by the voltage detection circuit,
the voltage conversion control unit determines whether the change in state is generated based on the amount of decrease in terminal voltage detected by the voltage detection circuit,
the voltage conversion control unit puts the voltage conversion circuit into the starting state when determining that the change in state is generated, and
the voltage conversion control unit keeps the voltage conversion circuit in the stopping state when determining that the change in state is not generated.

17. The charger according to claim 11, wherein
the voltage conversion circuit includes:
a converter configured to convert the supply voltage into the DC voltage; and
a signal transmitter configured to transmit the control signal to the converter.

18. The charger according to claim 17, wherein
the converter includes:
a power transformer that includes a primary winding and a secondary winding;
a primary rectifier circuit that rectifies the supply voltage to generate the DC voltage;
an AC voltage generator that generates an AC voltage based on the DC voltage output from the primary rectifier circuit, and supplies the AC voltage to the primary winding; and
a secondary rectifier circuit that generates the DC voltage by rectifying the AC voltage induced in the secondary winding.
